(19) United States
(12) Patent Application Publication
(10) Pub. No.: US 2005/0252257 A1
(43) Pub. Date: Nov. 17, 2005

(54) Padlock

(76) Inventors: Derek R. Woods, Gig Harbor, WA (US); Joe T. Burns, Lakewood, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 11/128,651

(22) Filed: May 12, 2005

Related U.S. Application Data
(60) Provisional application No. 60/570,249, filed on May 12, 2004.

(51) Int. Cl. E05B 67/36; E05B 67/38

(52) U.S. Cl. 70/33; 70/34; 70/56

(57) ABSTRACT

A tamper resistant padlock. The padlock includes a hasp receiving opening through which passes an extendable and rotatable lock shaft which secures the hasp or other lockable article. A shield is provided adjacent the bottom bore to protect the lock mechanism. The shield may be provided in a magnetic material to strongly attract ball bearings which protect the padlock against metal cutting drill bits.

### RELATED PATENT APPLICATIONS

This invention is related to U.S. Provisional Patent Application Ser. No. 60/570,249, filed May 12, 2004 entitled PADLOCK, the disclosure of which is incorporated herein in its entirety by this reference.

### COPYRIGHT RIGHTS IN THE DRAWING

A portion of the disclosure of this patent document contains material that is subject to copyright protection. The applicant no objection to the facsimile reproduction by anyone of the patent document or the patent disclosure, as it appears in the Patent and Trademark Office patent file or records, but otherwise reserves all copyright rights whatsoever.

### DRAWINGS

The patent or application file contains at least one black and white photograph as a drawing. Copies of this patent or patent application publication with black and white drawing(s) will be provided by the U.S. Patent and Trademark Office upon request and payment of the necessary fee.

### TECHNICAL FIELD

This patent application relates to padlocks, and in particular, to tamper resistant padlocks.

### BACKGROUND

Padlocks are used for securing all manner of openings against unauthorized entry. Many padlock designs use lock shackles which pass through apertures in hasps. Also, padlock designs have been proposed or used in which a lock shaft passes through apertures in the hasp but which locks retain the shaft internal to the lock body, to help protect the lock and hasps from being defeated by cutting the hasps or the lock shaft or shackles.

Many padlock designs can be breached by using a metal drill to drill thru the padlock body or housing, and then into the locking mechanism itself. To prevent successful drilling of a lock by a penetrating drill bit, some locks have been shielded by hardened balls such as metallic ball bearings. In such designs, if the drill does penetrate the lock body, when the drill reaches the balls, the balls simply spin, and cutting by the drill bit is effectively stopped. But, such a design is also defeated if the drill bit is able to slide past the balls to find non-rotating lock body material, or to push the ball firmly against a ball socket sufficiently to stop the ball from rolling.

It would be desirable to provide an improved padlock in which the use of drill defeating structures is carefully placed and controlled so as to minimize or prevent the possibility of a drill actually piercing through a shield, especially a shield including ball bearings, so that a padlock could not be defeated.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

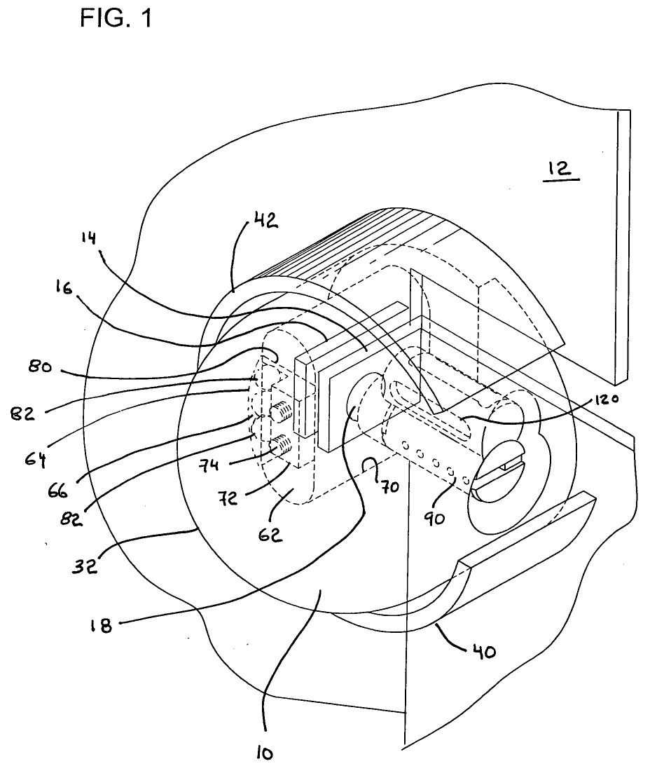

FIG. 1 is a perspective view of a tamper resistant padlock in a secure, locked position locking mating hasps on an article to lockably secured.

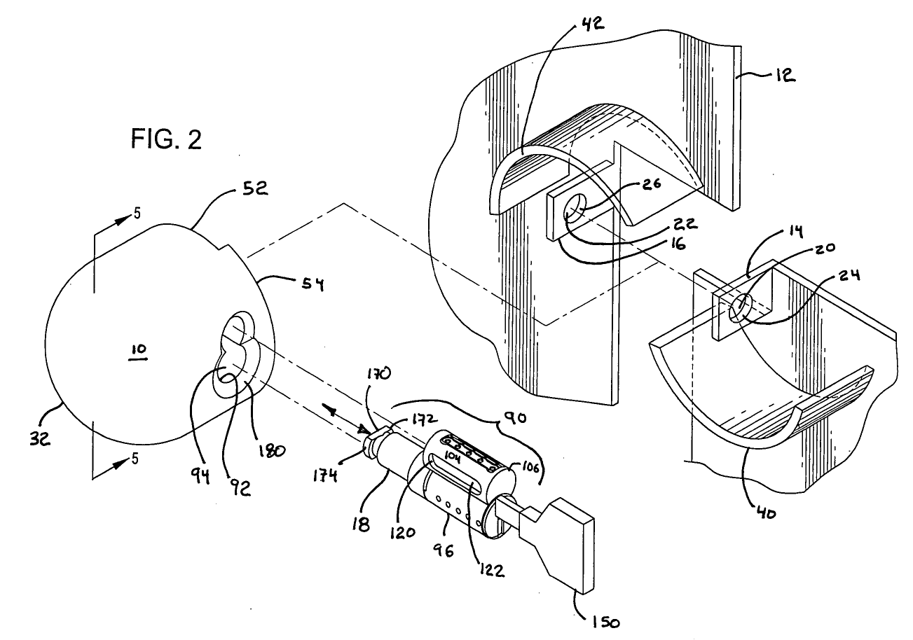

FIG. 2 is a partially exploded perspective view, showing the tamper resistant padlock just illustrated in FIG. 1 now in the detached, unlocked position, with a the cylinder lock mechanism released and removed therefrom.

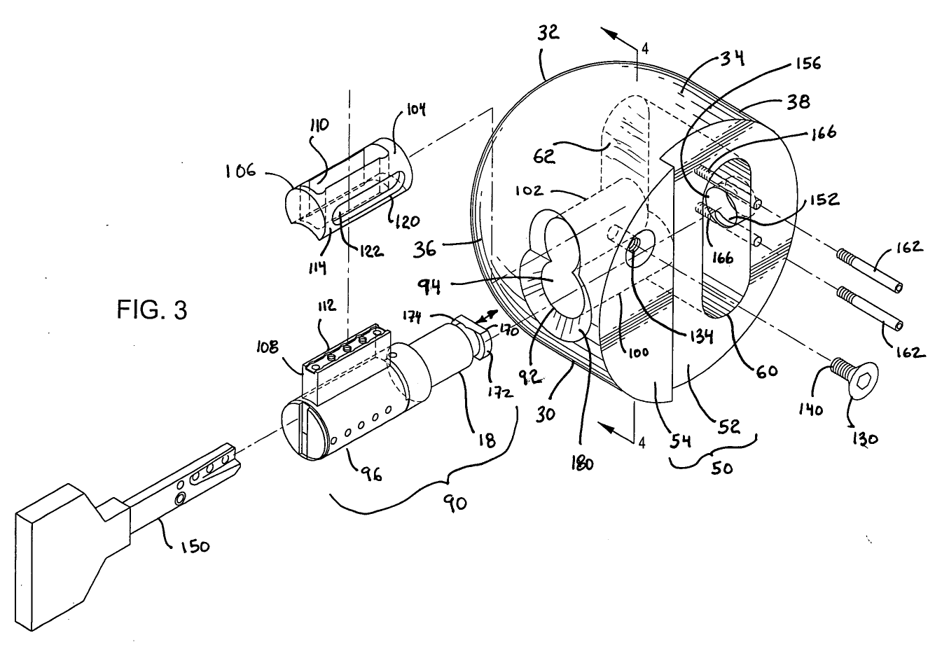

FIG. 3 is an exploded perspective of a tamper resistant padlock, showing the body, including its base, a generally domed outer shell, as well as internal details, including a cylinder lock mechanism with removable key.

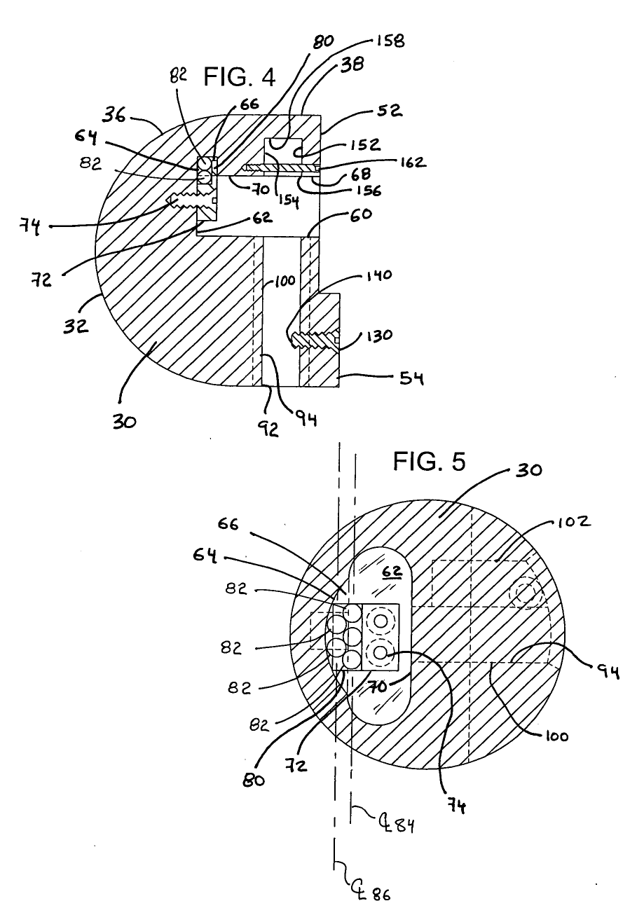

FIG. 4 is a cross sectional view, taken along line 4-4 of FIG. 3, showing internal details including shield and ball bearings retained by the shield.

FIG. 5 is a cross sectional view, taken along line 5-5 of FIG. 2, showing internal details including ball bearings retained by the shield.

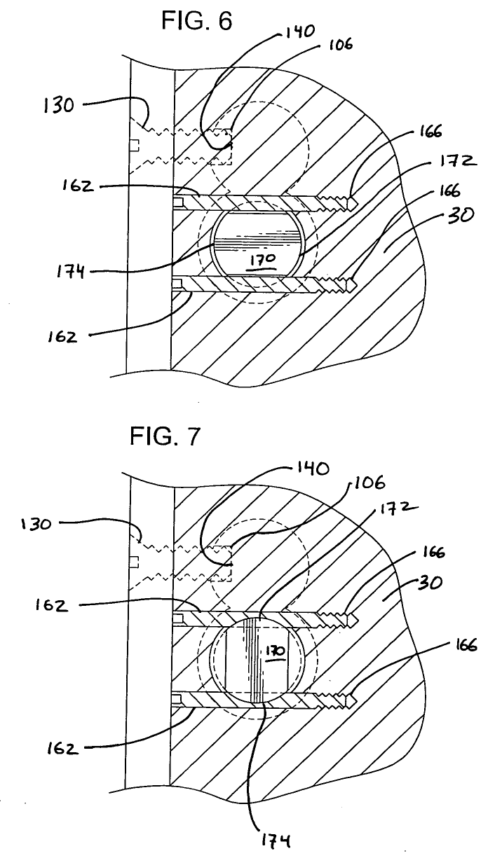

FIG. 6 is a cross sectional view, taken along a portion of line 4-4 of FIG. 3, showing the details of the locking flange on the distal end of the lock shaft when in the unlocked position.

FIG. 7 is a cross sectional view, taken along a portion of line 4-4 of FIG. 3, similar to FIG. 6, but now showing the details of the locking flange on the distal end of the lock shaft when in the locked position.

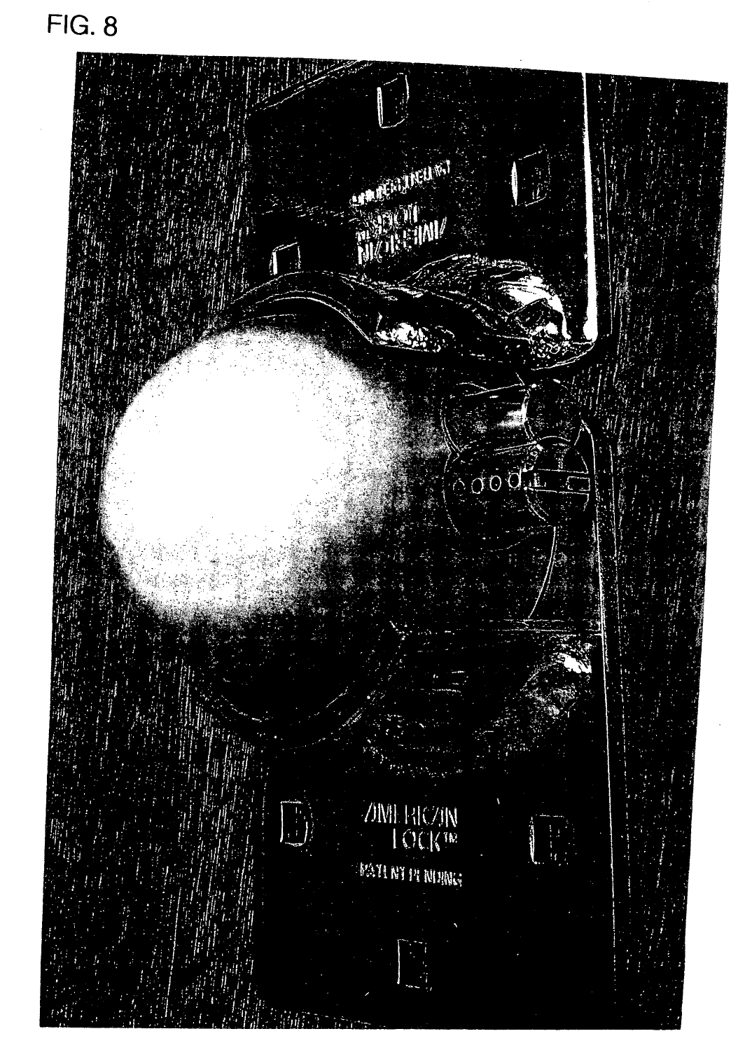

FIG. 8 is perspective view of a tamper resistant lock, shown in the unlocked position, but ready for locking adjacent hasps as might be used on equipment to be locked.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of an improved tamper resistant padlock. However, various other elements of a padlock, especially as applied for different variations of the functional components illustrated, as well as different embodiments of artistic elements such as a visual domed design, may be utilized in order to provide a robust tamper resistant padlock.

### DETAILED DESCRIPTION

As seen by comparison of FIG. 1 and FIG. 2, a tamper resistant padlock 10 is provided for securing a lockable structure 12 such as companion first 14 and second 16 hasp portions by way of an extensible lock shaft 18. As seen by in FIG. 2, first hasp portion 14 and second hasp portion 16 each have apertures 20 and 22 therein defined by sidewall portions 24 and 26. A lockable structure 12 is secured by placing lock shaft 18 through apertures 20 and 22 when the first 14 and second 16 hasp portions are brought to a locking engagement position as shown in FIG. 1.

Padlock 10 has a lock body 30 having a tamper resistant outer shell 32. In one embodiment outer shell 32 is hardened, such as by tempering of a suitable high strength steel alloy, to have a high degree of hardness, so as to resist drilling In one embodiment outer shell 32 is providing having an outer shell surface 34 with a Rockwell hardness of at least 59. To further resist hardness, the outer shell 32 may be provided in a domed shape, or a smooth surfaced domed shape. In one embodiment, the outer shell 32 may be provided having an upper portion 36 having a substantially hemispherical surface shape, and a lower portion 38 having a substantially cylindrical surface shape. As seen in FIGS. 1 and 2, some lockable structures may include first 40 and second 42 arcuate segments sized and shaped for close fitting engagement with the lower portion 38 of the outer shell 32, so as to thwart thieves in their attempt to gain access to padlock 10.

As seen in FIG. 3, the lock body 30 has a base 50 with a receiving portion 52 and a land portion 54. The land portion 54 protrudes outward from the body 30 with respect to the receiving portion 52. The receiving portion 52 is provided in raised fashion to allow, where necessary by way of the shape of the lockable structure 12, the first hasp portion 14 and second hasp portion 16 to reach the hasp receiving bore 60. The receiving bore 60 extends into the body 30 to an endwall 62. The endwall 62 has an undercut toe portion 64 extending into the body 30 to form a recessed chamber portion 66. The receiving bore 60 is defined by sidewalls 68 having an interior surface 70, and need not be provided in a strictly defined shape, although one useful embodiment shown for example in FIGS. 1 and 5 utilizes a bore wherein the sidewalls 68 define a generally oval solid or elliptical solid opening. The receiving bore 60 is sized and shaped for receipt of a lockable structure therein for secure locking engagement of the lockable structure with the lock shaft 18 of the padlock 10.

At the endwall 62 a shield plate 72 is provided. The shield plate 72 is securely affixed to the body 30, such as via one or more fasteners 74 to the endwall 62. The shield plate 72 includes a capture plate portion 80 extending into the recessed chamber portion 66 of the receiving bore 60. In one embodiment, the shield plate 72, or at least the capture plate portion 80 thereof, is provided in a magnetic material. In one embodiment the capture plate portion 80 is provided in a strongly magnetic material that attracts and magnetically secures a plurality of metallic ball bearings 82. In one embodiment, the metallic ball bearings are hardened, so as to be difficult to cut with conventional metal cutting tools such as drills. In one embodiment, to thwart thieves, the plurality of hardened ball bearings 82 are rotatably and magnetically attractable by, and are thus secured to and by the capture plate portion 80 of the shield plate 72. As seen in FIG. 5, the ball bearings 82 may be provided in at least one row, and in one embodiment seen in FIG. 5, two rows 84 and 86 as indicated by centerlines C₈₄ and C₈₆. The shield plate 72 is sized, shaped, and located to shield a lock mechanism 90 against destructive intrusion such as by action of a drill bit.

A lock housing 92 is provided in the body 30. The lock housing 92 is defined by at least one sidewall 94 extending from the outer shell 32 into the base 30. A lock mechanism 90 is operably secured in the lock housing 92. The lock mechanism 90 includes a key mechanism 96 and a moveable lock shaft 18.

As indicated in FIGS. 1, 3, and 4, in one embodiment the sidewall 94 which defines the lock housing 92 may include a first sidewall portion 100 substantially cylindrical in shape. In such an embodiment, the key mechanism may be provided in the form of a key cylinder, as illustrated in FIGS. 1, 3, and 8.

As shown in FIGS. 3 and 4, the lock housing 92 may also further include a second sidewall portion 102 that is also substantially cylindrical in shape, adapted for accepting and securing therein the generally cylindrical outer surface 104 of a bible housing 106. The bible housing 106 is to securely engage, for sliding engagement and protection, a bible 108 extending from a key mechanism 96. As shown in FIG. 3, in one embodiment, the bible 108 is protrudes from key mechanism 96 in a largely rectangular shaped extension from key mechanism 96. The bible housing 106 includes an interior slot defined by complementary shaped interior sidewalls 110 that allow the top 112 of the bible 108 to extend through the bible housing 106. Angularly offset from the axis of the interior slot, and on the outer portion 114 of the bible housing 106, is a registration slot 120. Registration slot 120 includes a recessed portion 122 for receiving and slidably securing therein a registration tool 130 such as a threaded fastener pin 132. The registration tool 130 is sized and shaped to be securely affixed within a registration tool accepting passageway such as threaded passageway 134. In such case, registration tool 130 may be provided in the form of a threaded fastener. In any event, the registration tool 130 includes an end portion 140 sized and shaped for registration engagement with the registration slot 120 in the bible housing 106. In one embodiment, the bible housing has 106 has a tubular shell and interior sidewalls defining a bible receiving slot, and in such case, the bible housing 106 is removable from the bible 108. Also, note in FIG. 3 that a key 150 may be utilized to open lock mechanism 90.

Turning now to FIGS. 3 and 4, padlock 10 includes lock shaft 18 receiving bore 152 is located within the body 30. The lock shaft receiving bore 152 is defined by lock shaft receiving bore sidewalls 154 and extends from a mouth 156 to a bottom 158. The moveable lock shaft 18 is sized and shaped for extension into and retraction out of the lock shaft receiving bore mouth 156 as the padlock 10 is moved from a locked to an unlocked position, respectively.

Adjacent to the mouth 156, one or more locking flange receiving features 160 are provided. In one embodiment the locking flange receiving features 160 can be provided by using one or more cylindrical posts 162 securely affixed to the body 30 adjacent to the mouth 156. A shown in FIG. 3, a pair of cylindrical posts 162 are provided in parallel at opposing sides of the mouth 156. As seen in FIGS. 3, 6, and 7, in one embodiment, each of the one or more cylindrical posts 162 are threadably 164 inserted into threaded receivers 166.

The locking mechanism may, in one embodiment be provided in the form of a Model T-100 cylinder from MUL-T-LOCK of Israel, a leading lock mechanism supplier. However, a variety of other vendors, and locking mechanisms, may be supplied in a tamper resistant padlock 10 as taught herein.

As shown in FIGS. 7 and 7, the lock shaft 18 is a rotatable lock shaft. The rotatable lock shaft 18 has distal end portion 170 having locking flanges 172 and 174, which are sized and shaped for locking engagement with the locking flange receiving features such as cylinders 162. The extensible and rotatable lock shaft 18 may provided be in excess of one inch displaceable length and a diameter of at least ⅜ inches or in larger sizes, such as ½ inch in diameter.

For further refinement, the padlock 10 may be provided with a lock housing 92 having an inwardly sloped flange 180.

It is to be appreciated that the various aspects and embodiments of a tamper resistant padlock device as described herein is an important improvement in the state of the art. The tamper resistant padlock is simple, robust, reliable, and susceptible to use in a variety of applications. Although only a few exemplary embodiments have been described in detail, various details are sufficiently set forth in the drawings and in the specification provided herein to enable one of ordinary skill in the art to make and use the invention(s), which need not be further described by additional writing in this detailed description.

Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings.

1. A padlock, comprising:
a lock body, said lock body comprising
a tamper resistant outer shell,
a base, said base having a receiving bore therein, said receiving bore extending to an end wall having an undercut toe portion extending into said body to form a recessed chamber portion therein, said receiving bore defined by sidewalls having an interior surface, said receiving bore sized and shaped for receipt of a lockable structure therein for secure locking engagement of said lockable structure with said padlock,
a shield plate, said shield plate affixed to said end wall of said receiving bore in said base, said shield plate comprising a capture plate portion extending into said recessed chamber portion of said receiving body,
a lock housing, said lock housing defined by at least one sidewall extending from said outer shell into said base,
a lock mechanism, said lock mechanism operably secured in said lock housing, said lock mechanism comprising a key mechanism and a moveable lock shaft.

2. The padlock as set forth in claim 1, further comprising a plurality of hardened ball bearings, said hardened ball bearings rotatably secured by said capture plate portion of said shield plate.

3. The padlock as set forth in claim 2, wherein said shield plate is magnetic, and wherein said hardened ball bearings are magnetically attractable.

4. The padlock as set forth in claim 2, wherein said plurality of ball bearings comprises at least one row of ball bearings.

5. The padlock as set forth in claim 1, wherein said shield plate is sized, shaped, and located to shield said lock mechanism against destructive intrusion such as by action of a drill bit.

6. The padlock as set forth in claim 1, wherein said sidewall defining said lock housing comprises a first sidewall portion substantially cylindrical in shape, and wherein said key mechanism comprises a key cylinder.

7. The padlock as set forth in claim 6, wherein said lock housing further comprises a second sidewall portion substantially cylindrical in shape, and wherein said lock mechanism further comprises
a bible extending from said key cylinder, and
a bible housing,
and wherein said bible housing is slidably secured within said second sidewall portion of said lock housing.

8. The padlock as set forth in claim 7, wherein said bible housing further comprises a registration slot, and wherein said lock body further comprises (a) a registration accepting passageway defined by interior sidewally portions, and (b) a registration tool securely affixed within said registration accepting passageway.

9. The padlock as set forth in claim 8, wherein said registration accepting passageway comprises a threaded passageway, and wherein said registration tool comprises a threaded fastener, said threaded fastener having an end portion sized and shaped for registration engagement with said registration slot in said bible housing.

10. The padlock as set forth in claim 1, wherein a lock shaft receiving bore is located within said body, and wherein said lock shaft receiving bore is defined by lock shaft receiving bore sidewalls and extends from a mouth to a bottom, and wherein said moveable lock shaft is sized and shaped for extension into and retraction out of said lock shaft receiving bore mouth as said padlock is moved from a locked to an unlocked position, respectively.

11. The padlock as set forth in claim 10, further comprising, adjacent said lock shaft receiving bore mouth, one or more locking flange receiving features.

12. The padlock as set forth in claim 11, wherein said moveable lock shaft comprises a rotatable lock shaft, and wherein said rotatable lock shaft comprises a distal end portion comprising locking flanges, said locking flanges sized and shaped for locking engagement with said locking flange receiving features.

13. The padlock as set forth in claim 11, wherein said locking flange receiving features comprise one or more cylindrical posts securely affixed to said body adjacent said mouth.

14. The padlock as set forth in claim 13, wherein a pair of cylindrical posts are provided in parallel at opposing sides of said mouth.

15. The padlock as set forth in claim 13, wherein each of said one or more cylindrical posts are threadably inserted into threaded receivers.

16. The padlock as set forth in claim 1, wherein said lock housing further comprises an inwardly sloped flange.

17. The padlock as set forth in claim 1, wherein the outer shell has a generally domed shaped upper portion

18. The padlock as set forth in claim 1, wherein the outer shell has a generally hemispherical shaped upper portion.

19. The padlock as set forth in claim 1, wherein the outer shell has generally cylindrically shaped lower portion.

20. The padlock as set forth in claim 7, wherein said bible housing comprises a tubular shell and interior sidewalls defining a bible receiver slot, and wherein said bible housing is removable from said bible.

21. The padlock as set forth in claim 1, wherein said base comprises a receiving portion and a land portion, and wherein said land portion protrudes outward from said body with respect to said receiving portion.

22. The padlock as set forth in claim 1, wherein said outer shell comprises a surface portion having a Rockwell hardness of at least 59.

23. The padlock as set forth in claim 1, wherein said outer shell comprises a generally domed shaped structure.

24. The padlock as set forth in claim 1, wherein said outer shell comprises a generally hemi-spherical shaped upper portion.

25. The padlock as set forth in claim 1, wherein said outer shell comprises a generally cylindrical shaped lower portion.

26. The padlock as set forth in claim 1, wherein said lock shaft has a length of greater than one inch.

27. The padlock as set forth in claim 1, wherein said lock shaft has a diameter of one-half inch or more.
